(19) United States
(12) Patent Application Publication
(10) Pub. No.: US 2010/0050102 A1
(43) Pub. Date: Feb. 25, 2010

(54) SYMBOL DISPLAY METHOD AND SYMBOL DISPLAY DEVICE

(75) Inventors: Takayuki Baba, Kawasaki (JP); Masaki Ishihara, Kawasaki (JP); Susumu Endo, Kawasaki (JP); Shuichi Shiitani, Kawasaki (JP); Yusuke Uehara, Minato (JP); Daiki Masumoto, Kawasaki (JP); Shigemi Nagata, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/540,935

(22) Filed: Aug. 13, 2009

(30) Foreign Application Priority Data
Aug. 22, 2008 (JP) 2008-214476

(51) Int. Cl. G06F 3/048

(52) U.S. Cl. 715/765

(57) ABSTRACT

A symbol display device that displays a symbol for data while disposing the symbol at a coordinate position indicated by the data concerned, includes a pre-movement image position obtaining unit that records into a recording unit a pre-movement coordinate position at which the symbol is disposed; an image moving unit that moves the symbol to a coordinate position indicated by an instruction upon reception of the instruction; a post-movement image position obtaining unit that records, into the recording unit, a post-movement coordinate position of the symbol moved by the image moving unit; and a connection line drawing unit that connects the post-movement coordinate position and a pre-movement coordinate position by a line, and changing the line thickness of the connecting line or the size of the symbol.

### CROSS-REFERENCE TO RELATED APPLICATIONS

This application is based upon and claims the benefit of priority of the prior Japanese Patent Application No. 2008-214476, filed on Aug. 22, 2008, the entire contents of which are incorporated herein by reference.

### FIELD

This invention relates to a technique of displaying a symbol such as an icon, an image, or the like for data while arranging the symbol at a coordinate position indicated by the data.

### BACKGROUND

There has hitherto existed a technique of disposing a symbol such as an icon, an image, or the like for data at a coordinate position indicated by the data and displaying the relation between the data and the coordinate position of the data, that is, the attribute value of the data.

FIG. 14 is a diagram depicting a conventional graph display example. In a medical institution such as a hospital, a medical clinic office, or the like, when a specification of a medical care cost for a patient is described as a receipt to charge an insurer, a total score and the number of medical care days are plotted on the abscissa axis and the ordinate axis of a graph respectively to thereby dispose receipt data on the graph.

Based on files read from a receipt computing system, receipt data are displayed while the number of medical care days and the total score are set on the coordinate axes. An user searches and analyzes the relation between the number of medical care days and the total score while checking the content of the displayed specification.

In the example of the graph display of FIG. 14, when there exist receipts which are identical or close to each other in the number of medical care days and the total score, the receipts have been generally displayed so as to overlap each other on the graph.

For example, a technique of displaying a locus of a figure (part) created by a CAD (Computer Aided Design) system when the figure (part) is moved has been provided as a well-known technique of enhancing visibility of the data displayed on the graph screen and operability of users (for example, Japanese Laid-open Patent Publication No. 05-266164).

Furthermore, there has also been provided a technique of moving figures while keeping the relative positional relationship between the figures in order to prevent the overlapping of the figures on a display screen (for example, Japanese Laid-open Patent Publication No. 2001-134261).

Still furthermore, there has also been provided a technique of displaying objects while the scale size of the overall image is reduced or the objects are demagnified when there is some overlap between the arranged objects (for example, Japanese Laid-open Patent Publication No. 2000-298679).

### SUMMARY

According to an aspect of the embodiment, an apparatus includes a symbol display device that displays a symbol for data while disposing the symbol at a coordinate position indicated by the data concerned; a pre-movement image position obtaining unit that records, into a recording unit, a pre-movement coordinate position at which the symbol is disposed; an image moving unit moving the symbol to a coordinate position indicated by an instruction to move the symbol upon reception of the instruction;

a post-movement image position obtaining unit that records, into the recording unit, a post-movement coordinate position of the symbol moved by the image moving unit; and a connection line drawing unit that connects the post-movement coordinate position and the pre-movement coordinate position recorded in the recording unit by a line, and changing the line thickness of the connecting line or the size of the symbol after the movement in accordance with the distance between the pre-movement and post-movement coordinates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating the construction of a multimedia search device according to an embodiment;

FIG. 2 illustrates an example (part 1) of a screen when an image group is moved;

FIG. 3 illustrates an example (part 2) of the screen when the image group is moved;

FIG. 4 is a diagram illustrating a method of determining the arrangement of images;

FIG. 5 is a diagram illustrating a method of determining a display position and a display size of each image after the movement;

FIG. 6 is a flowchart illustrating the overall processing of displaying the image group in a graph style;

FIG. 7 is a flowchart illustrating the details of movement processing of the image group;

FIG. 8 is a diagram illustrating another method of determining the arrangement of the images;

FIG. 9 illustrates an example (part 3) of the screen when the image group is moved;

FIG. 10 illustrates an example (part 4) of the screen when the image group is moved;

FIG. 11 illustrates an example (part 5) of the screen when the image group is moved;

FIG. 12 is a diagram illustrating the construction of an information processing device;

FIG. 13 is a diagram illustrating a computer-readable recording medium which can supply programs and data to the information processing device; and

FIG. 14 is a diagram illustrating a graph display example in a related art.

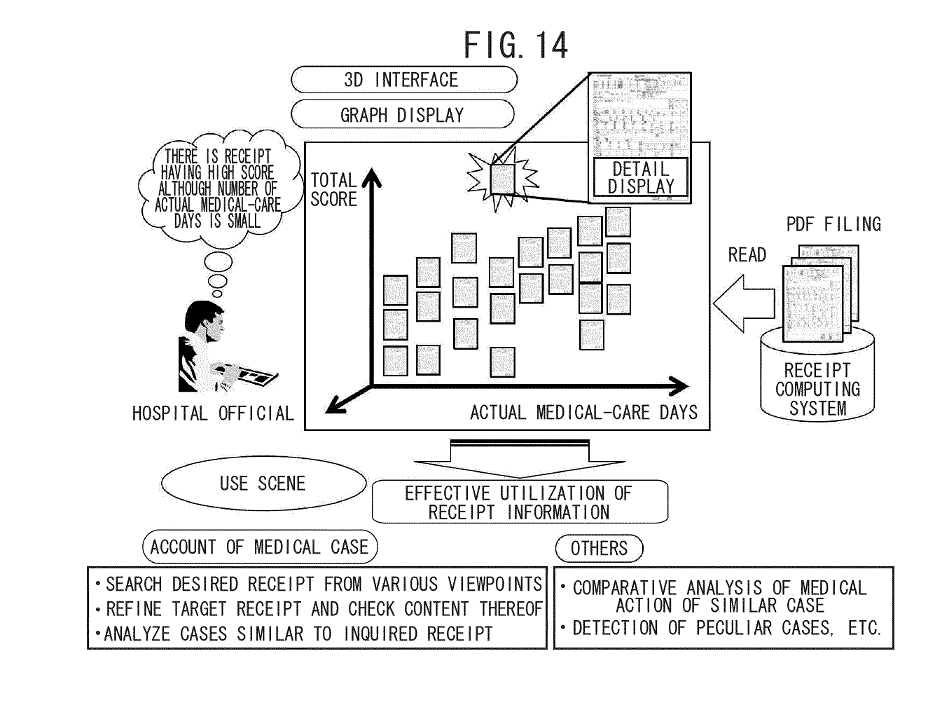

### DESCRIPTION OF EMBODIMENTS

Embodiments of the present invention will be described hereunder in detail with reference to the drawings. Here, an image is used as an example of a symbol.

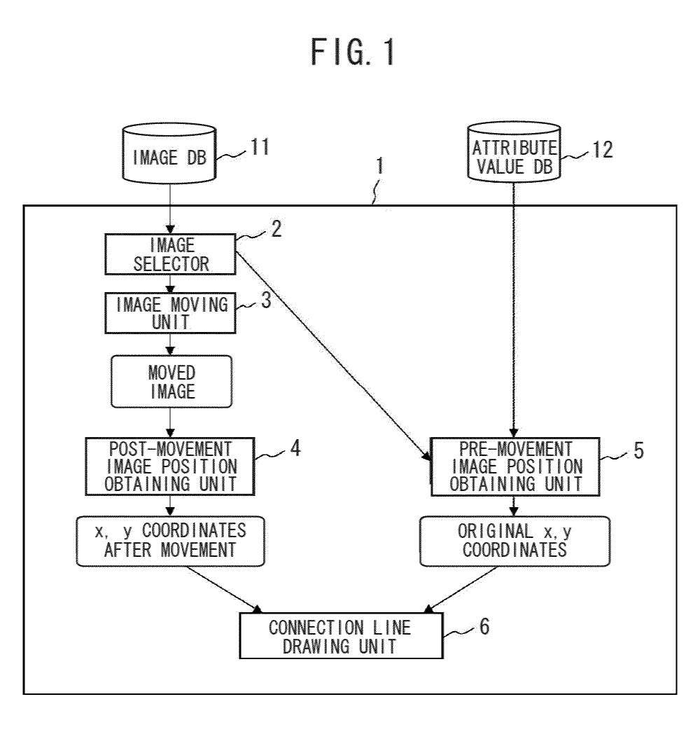

FIG. 1 is a diagram illustrating the construction of a multimedia search device according to an embodiment of the present invention. The multimedia search device 1 illustrated in FIG. 1 is connected to an image database (image DB) 11 and an attribute value database (attribute value DB) 12, and has an image selector 2, an imaging moving unit 3, a post-movement image position obtaining unit 4, a pre-movement image position obtaining unit 5, and a connection line drawing unit 6.

Image data to be displayed in a graph style are stored in the image database 11. Attribute value data for each image data of the image database 11 is stored in the attribute value database. The multimedia search device 1 reads multimedia information such as image data stored in the image database 11, etc. In connection with this reading of the multimedia information, the multimedia search device 1 reads the attribute value data stored in the attribute value database 12. The multimedia search device 1 allocates the attribute to the x-axis and the y-axis, and displays the image on the graph.

When images input from the image database 11 are displayed in a graph style, the image selector 2 selects images which would be superposed on a graph owing to attribute values. For example, when an instruction of moving images having superposed portions is input by a user, the image selector 2 selects the images to be moved. In this embodiment, in addition to images having the same attribute value, images which have near attribute values and thus are partially overlapped with one another are also selected as selection targets by the image selector 2. In the following description, plural images which are selected by the image selector 2 and also should be moved are referred to as an “image group”.

The image moving unit 3 moves the images of the image group selected by the image selector 2 to specific positions so that the images of the image group do not overlap one another. A specific method for moving the images will be described later.

The post-movement image position obtaining unit 4 and the pre-movement image position obtaining unit 5 obtain the position coordinates of the images after and before the image group is moved by the image moving unit 3, respectively. The obtained position coordinates of the images before and after the movement are recorded in a recording unit (not illustrated).

The connection line drawing portion 6 draws lines connecting the position coordinates before and after the movement, etc. on a graph screen based on the position coordinates before and after the movement which are recorded in the recording unit.

As described above, according to the multimedia search device 1 of this embodiment, with respect to the image group of which images are superposed on the graph when these images are displayed on the graph based on the attribute values, the images are moved to positions at which each of these images do not overlap the other images, and the position coordinate of each image before the movement is connected by a line to the position coordinate of the image after the movement. When there are images which are superposed because they have the same attribute value or near attribute values, these images are moved and displayed on a graph so that these images do not overlap. With respect to the original (pre-movement) position coordinates, that is, the attribute values of the images, the original position coordinates of the images are connected by lines to the coordinate positions of the images after the movement. A user can easily check the contents of the images and the attribute values through the graph.

In FIG. 1, the image database 11 and the attribute value database 12 are provided outside of the multimedia search device 1, and the image data and the attribute value data are respectively read out from these databases and used. However, the present invention is not limited to this construction. These databases may be installed in the multimedia search device 1.

With respect to the time period for which the display positions of the image group are to be moved, the time period may be limited to a specific time period from the time when a user's instruction of moving overlapped images is accepted. After the specific period elapses, the display positions may be returned to the original positions.

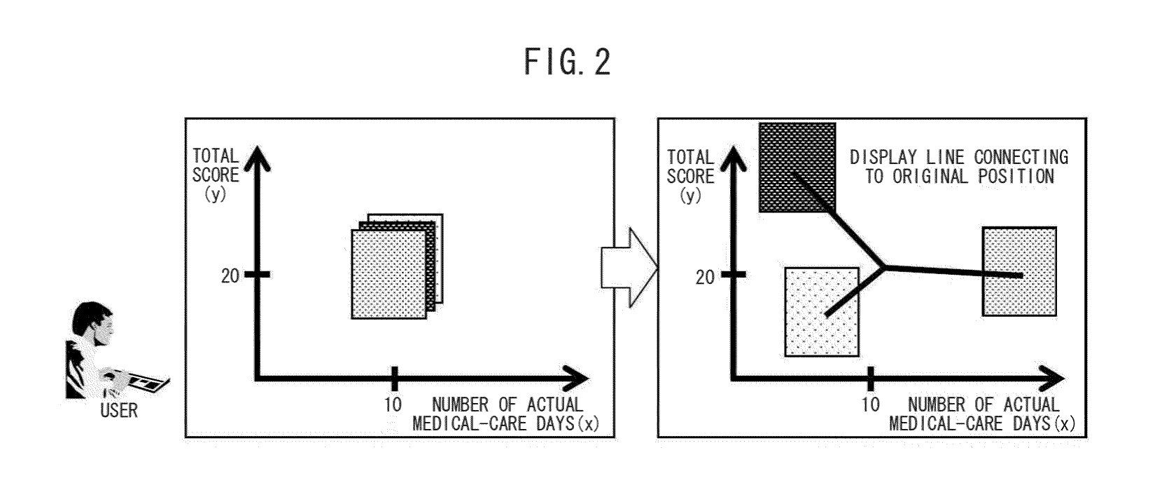

FIG. 2 illustrates an example of the screen when the image group is moved by the multimedia search device 1 according to this embodiment. In FIG. 2, there exist three images whose attribute values (x, y) are equal to the same values (10, 20).

As illustrated in FIG. 2, according to the multimedia search device 1 of this embodiment, with respect to the image group, the respective images are moved to positions at which they do not overlap with one another, and then the position coordinates of the original (pre-movement) images are connected by lines to the position coordinates of the moved images. With respect to the image group whose images overlap with one another due to attribute values, these images are moved and displayed so that they do not overlap with one another, and also the position coordinates before the movement are displayed on the graph screen. Therefore, there is an advantage that the user can easily analyze the images displayed on the graph screen, etc.

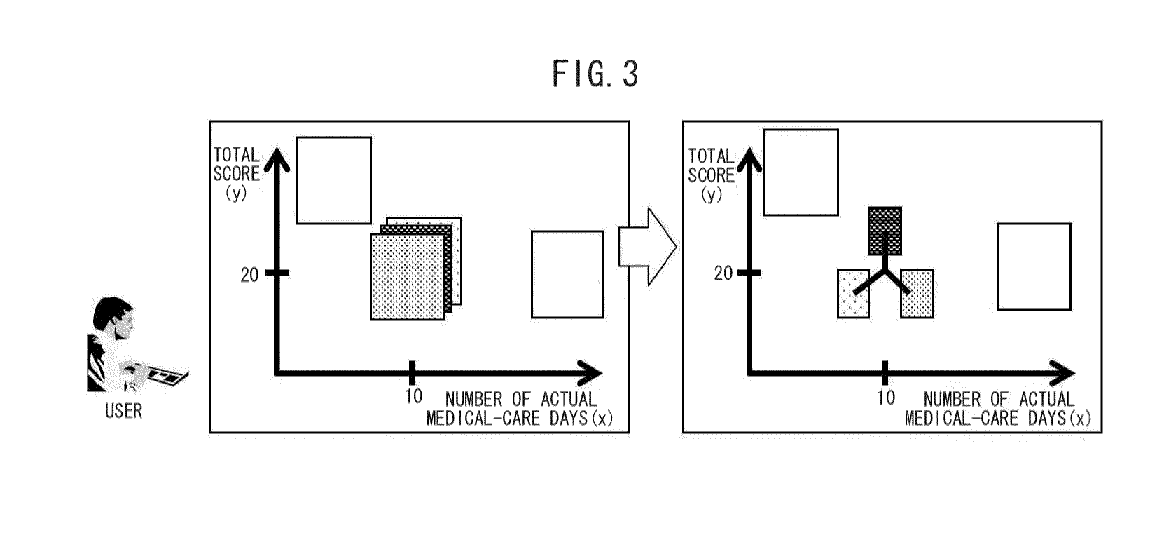

FIG. 3 illustrates another example of the screen when an image group is moved by the multimedia search device 1 according to this embodiment. On the graph screen illustrated in FIG. 3, the images of the image group are displayed in a scale-down mode so that the images of the moved image group do not overlap with other images, and then the position coordinates of each image before and after the movement are connected to each other by a line as in the case of the display example of FIG. 2.

As described above, by changing the display size of the image group after the movement, a desired image group can be moved while no overlap occurs between the image group concerned and each unmoved image.

A method of moving the image group so that the moved image group does not overlap with unmoved images will be specifically described.

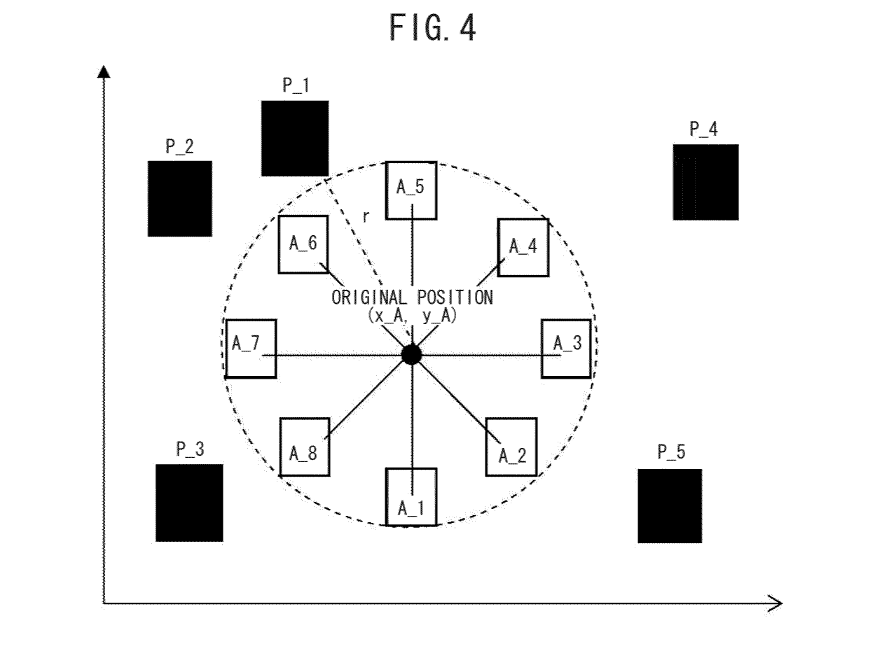

FIG. 4 is a diagram illustrating a method of determining the arrangement of images. The following description will be made by introducing case where five images P_1 to P_5 are displayed on the screen in addition to the image group selected by the image selector 2 of FIG. 1 as illustrated in FIG. 4.

The images (P_1 to P_5) other than the selected image group, that is, the images whose display positions should be moved may actually contain a plurality of images, however, in this case, the images other than the image group for which the arrangement should be determined are represented as an “image” for the purpose of simplifying the description.

The images contained in the image group are represented by A_N (N represents an integer of 1 or more). FIG. 4 illustrates a case where the image group contains eight images A_1 to A_8. The original position coordinate of the image group is set to (x, y)=(x_, y_A). In this case, the position coordinate of the image represents the coordinate at the center of the image.

In order to display the images of the image group so that these images do not overlap with the other images P_1 to P_5 after the movement, a distance r between the original position coordinate (x_A, y_A) and an image P_i (P=1, 2, . . . M, M represents the number of non-selected images) located at the shortest distance from the original position coordinate is determined, and the images of the image group are moved to the peripheral edge portion of a circle having a radius of r. Here, the position coordinate of the image P_i is represented by (x_Pi, y_Pi). It is assumed that the image P_i is rectangular, and the size thereof is represented by 2s_x(P_i) on the short side (x-axis direction) and 2s_y(P_i) on the long side (y-axis direction). In the example of FIG. 4, the image P_1 located at the coordinate (x_P1, y_P1) is the image nearest to the image group.

The distance r between the image group and the nearest image is determined according to the following formula (1):

[formula I]

r=min(\sqrt{(x_{A}−xₚ_{ᵢ})²+(y_{A}−yₚ_{ᵢ})²}−{square root over ((sₓ(Pᵢ)²+x_{y}(Pᵢ)²))}) (1)

The first term at the right-hand side represents the distance between the center positions of the image group and the nearest image, and the second term at the right-hand side represents the distance between the center position of the nearest image and the corner of the image concerned.

With respect to the original (pre-movement) position coordinate, it is not necessarily required that the position coordinates of plural images contained in the image group are coincident with one another. Even when the position coordinates of the respective images are different from one another, for example, an average position coordinate, a center coordinate, or the like may be calculated from the position coordinates of the respective images, and used as the original position coordinate (x_A, y_A) to execute the above calculation.

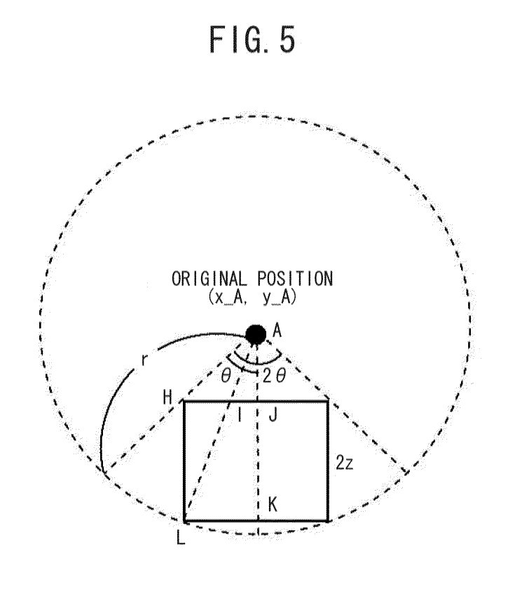

FIG. 5 is a diagram illustrating a method of determining the display position and display size of each image after the movement. For example, the display position and display size of each image are determined so that the image group is arranged on the circle having the radius of r calculated according to the formula (1).

According to the method illustrated in FIG. 5, the circle of the radius r containing the coordinate (x_A, y_A) of the center of the image group at the center is equally divided by the number of images N with respect to the center of the image group. As illustrated in FIG. 5, each of the sectors obtained by equally dividing the circle by N with respect to the center of the circle is a sector having an angle of 2θ (θ=360°/2N). A square which internally touches the obtained sectorial area is determined, and the image size is changed while keeping the aspect ratio constant so that the image is accommodated in the square.

Specifically, a right triangle HJA is first considered. ∠HJA=90° and ∠HAJ=θ are satisfied, and thus (length of AJ)=z/tan θ is satisfied. As a result, (the length of AK)=(the length of AJ)+(the length of JK), that is, (the length of AK)=z/tan θ+2z is satisfied for a line segment AK.

Next, a right triangle LKA is considered. ∠LKA=90° is satisfied, and thus (square of the length of AL)=(square of the length of AK)+(square of the length of LK) is satisfied according to the Pythagorean theorem. That is, the following formula (2) is satisfied.

$$\begin{matrix}[ Formula 2 ] & \\ {r}^{2} = {( \frac{z}{tan θ} + 2 z )}^{2} + {z}^{2} & ( 2 )\end{matrix}$$

By solving the formula (2) with respect to z, the following formula is obtained.

$$\begin{matrix}[ Formula 3 ] & \\ z = \frac{r}{\sqrt{1 + {( \frac{1}{tan θ} + 2 )}^{2}}} & \end{matrix}$$

As described above, the square in which the length of one side is equal to 2z is determined, and the image size is determined so that the image is accommodated in the square. A sectorial area is allocated to each image, and the display position of the image is determined in accordance with the position of the allocated sectorial area.

The display method of the image group described above will be described with reference to a flowchart.

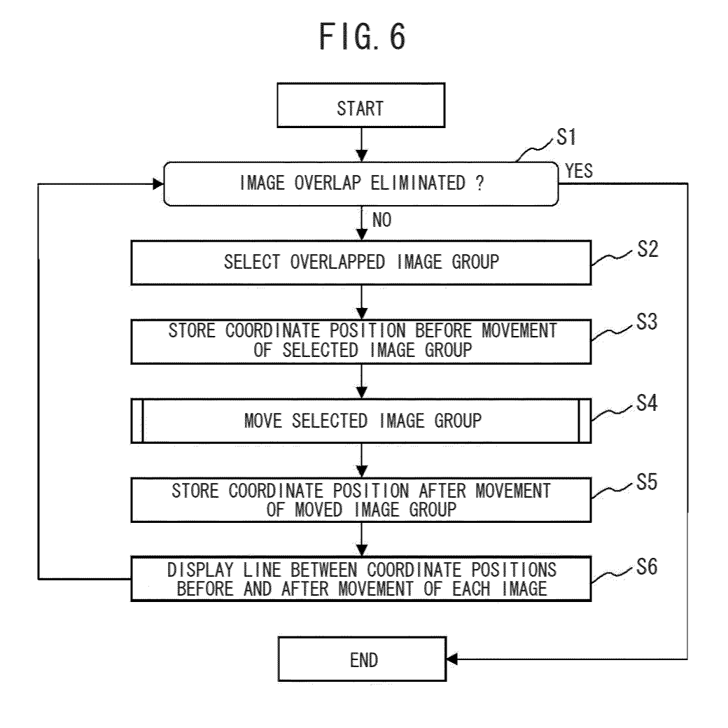

FIG. 6 is a flowchart illustrating the overall processing of displaying the image group in the graph style in the multimedia search device 1 according to the embodiment. First, in step S1, the multimedia search device 1 determines whether overlap of images displayed on a graph is eliminated or not. When it is determined that there is no overlap between images displayed on the graph, the multimedia search device 1 does not execute any processing and thus finishes the processing. When there exist overlapped images out of the images displayed on the graph, the multimedia search device 1 goes to step S2.

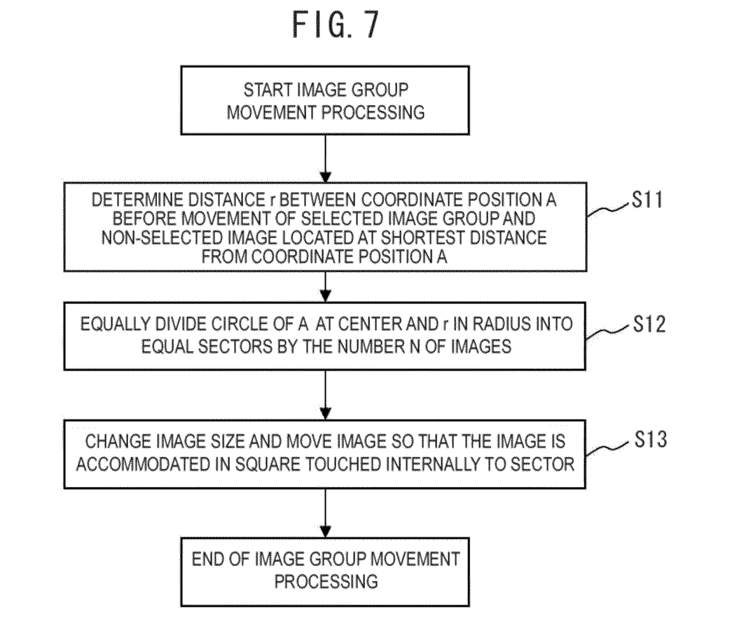

In step S2, the image selector 2 selects a plurality of images (image group) having overlapped portions. In step S3, the pre-movement image position obtaining unit 5 stores the position coordinate of each image of the selected image group in the recording unit. In step S4, the image moving unit 3 moves the selected image group. The details of the movement processing of the image group in step S4 will be described with reference to FIG. 7.

In step S5, with respect to the moved image group, the post-movement image position obtaining unit 4 stores the post-movement position coordinate of each image into the recording unit. In step S6, the connection line drawing unit 6 connects, through a line, the position coordinates of each image before and after the movement which are read out from the recording unit, and then the processing returns to step S1.

FIG. 7 is a flowchart illustrating the details of the movement processing (step S4 of FIG. 6) of the image group. First, in step S11, with respect to the image group selected in step S2 of FIG. 6, the image moving unit 3 determines the distance from the coordinate position A before the movement to the non-selected image located at the shortest distance from the coordinate portion A. The method of calculating the distance from the coordinate position before the movement to the nearest non-selected image is described above with reference to FIG. 4.

In step S12, the image moving unit 3 equally divides the circle of the radius r containing the position A of the pre-movement image group at the center of the circle by the number N of selected images (the number of images contained in the selected image group), thereby obtaining N sectors.

In step S13, the image moving unit 3 changes the image size so that the images are accommodated in squares which internally touch the obtained sectors, moves the images to the squares, and then finishes the processing.

When a plurality of image groups exist, if there exist image groups other than the selected image group, which have been already moved when the distance to the image located at the shortest distance (i.e., the nearest image among the non-selected images) is determined in step S11, the image moving unit 3 refers to the post-movement position coordinates of the other image groups and calculates the distance to the nearest image.

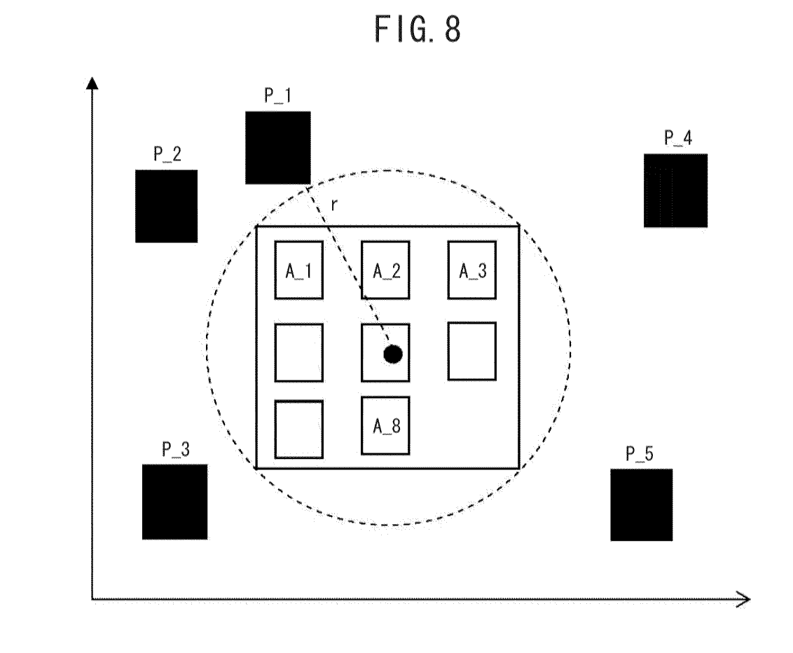

FIG. 8 is a diagram illustrating another method of determining the arrangement of the images. This method is identical to the method illustrated in FIG. 4 in that the distance r to the image nearest to the image group is determined, the circle of the radius r is divided into equal areas, the equal areas are allocated to respective images and the images are moved to the respective areas. According to the method illustrated in FIG. 4, the images are arranged along the peripheral edge portion of the circle of the radius r. However, the method illustrated in FIG. 8 is different from the method of FIG. 4 in that a rectangle which internally touches the circle is divided into n parts in the longitudinal direction and m parts in the lateral direction (n and m represent natural numbers), and respective image areas are allocated in the grid-like arrangement in the obtained rectangle.

In the example of FIG. 8, it is assumed that the image group contains eight images A_1 to A_8 and five images P_1 to P_5, which are images other than the selected image group are provided. The calculation method of the radius r is identical to that described above. The rectangle which internally touches the circle of the radius r is divided into 3×3 areas, and the images A_1 to A_8 are respectively moved to eight areas of the 3×3 areas.

As illustrated in FIG. 8, when the images of the image group are disposed in the grid-like arrangement, an image may be displayed at the coordinate position before the movement. In such a case, it is not necessarily required to connect the coordinate positions before and after the movement by a line, and the original coordinate position may be indicated on the graph.

When the movement processing of the image group is executed, the processing of the steps S12 and S13 of FIG. 7 is not executed. In place of this processing, the above processing is executed after the distance to the nearest non-selected image is calculated in step S11, whereby the images contained in the image group can be re-arranged in the grid form.

In the above embodiment, the distance r to the image which is nearest to the image group among the non-selected images is determined and the image group is moved along the circle of the radius r so as to prevent some image of the image group from overlapping with another image when the image group is moved. However, the movement destinations of the image group are not limited to the above places. By referring to the display positions of other images (non-selected images), the images of the image group may be respectively moved to positions at which the other images on the graph are not displayed. Or, the respective images may be moved so that the area of the gap between the moved images is minimal. Furthermore, the respective images may be moved to specific places indicated by a user at a specific timing.

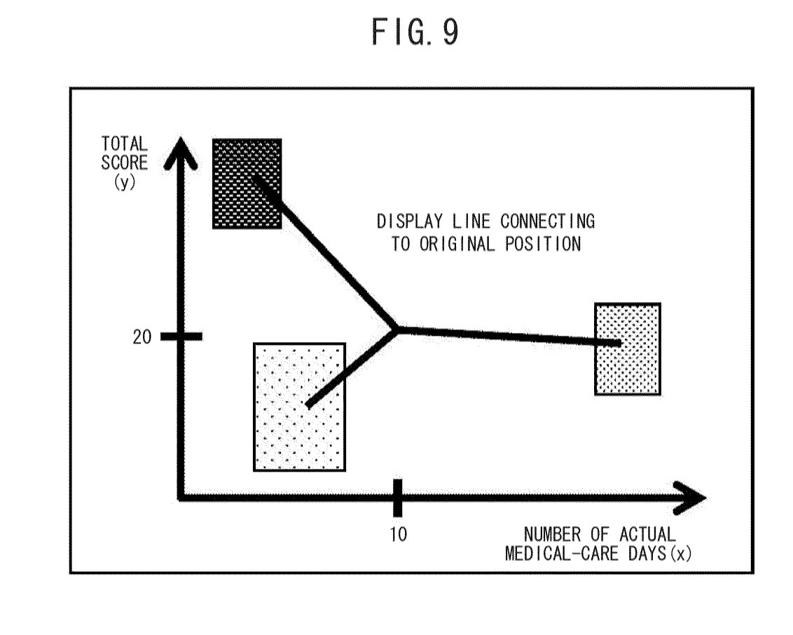

FIG. 9 is a diagram illustrating another example of the screen display. As illustrated in FIG. 9, the display size of the image after the movement may be changed in accordance with the movement distance of the image when the image group is moved. In the example of FIG. 9, the display size is set to be smaller as the movement distance is longer.

By displaying the image so that the display size is smaller as the movement distance of the image is longer as described above, the visibility of the graph is enhanced, and thus the user can easily perform tasks such as analysis, etc. through the graph screen.

As another example, the image may be displayed to be more faint or more transparent in accordance with the movement distance of the image as the movement distance is longer. Furthermore, the image may be displayed with a dot on the graph when the movement distance is long. In the above cases, the same effect as the case where the image size is changed in accordance with the movement distance as illustrated in FIG. 9 can be achieved.

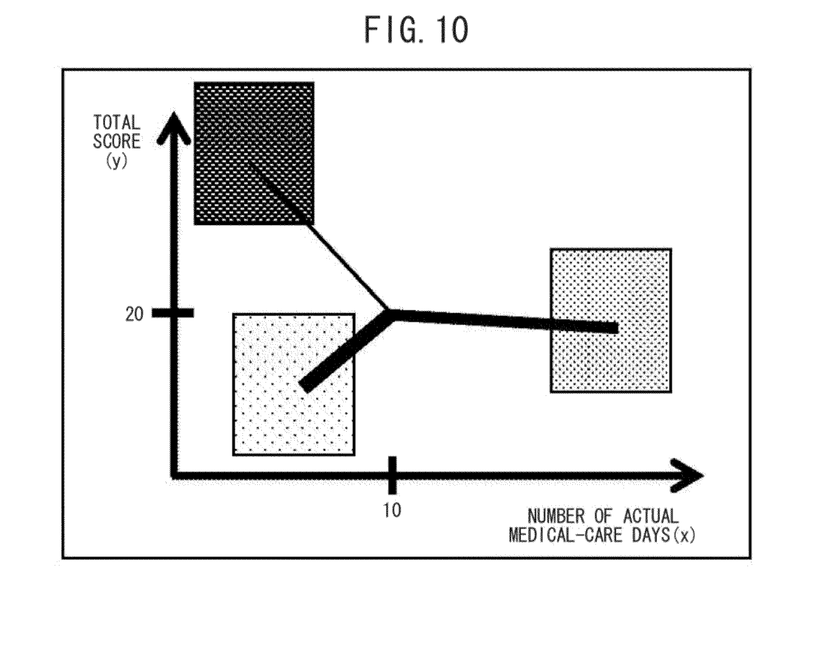

FIG. 10 is a diagram illustrating another example of the screen display. The line thickness of a line connecting the coordinates before and after the movement may be changed in accordance with the movement distance of the image as illustrated in FIG. 10 when the image group is moved. In the example of FIG. 10, as the movement distance is longer, the line is made thinner.

As described above, the line length increases as the image is moved to a farther place. However, even in such a case, the line is displayed to be thinner as the movement distance of the image is longer, thus the level that the line concerned disturbs the display of other images can be suppressed. Accordingly, the visibility of the graph is enhanced, and the user can easily perform the tasks such as analysis, etc. through the graph screen.

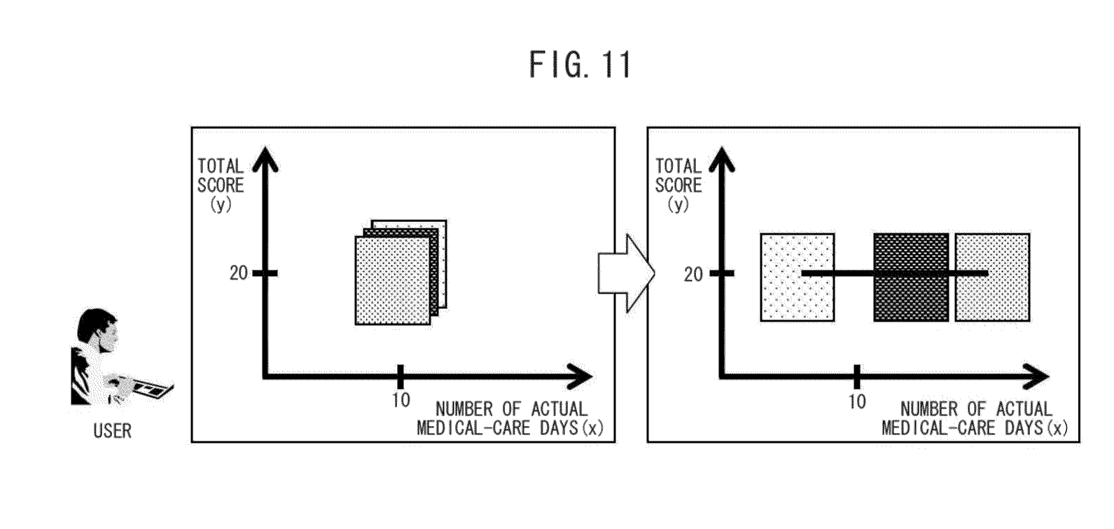

FIG. 11 is a diagram illustrating another example of the screen display. As illustrated in FIG. 11, the moving direction of the image group may be limited to one direction. In the example of FIG. 11, the moving direction is limited to the x-axis direction.

As described above, by limiting the moving direction of the image group to a certain direction, the user may pay his/her attention to only the direction concerned. Accordingly, the load imposed on the user can be reduced, and thus the user can easily perform other tasks such as analysis, etc. through the graph screen.

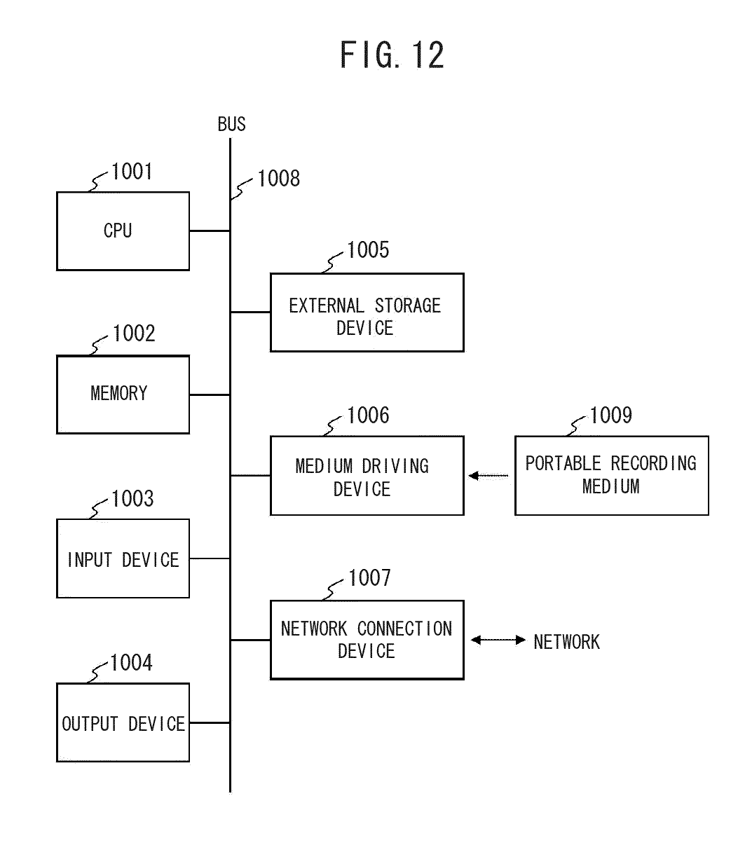

An information processor (computer) as illustrated in FIG. 12 may be used as the multimedia search device 1 of FIG. 1, for example. The information processor of FIG. 12 includes a CPU (central processing unit) 1001, a memory 1002, an input device 1003, an output device 1004, an external storage device 1005, a medium driving device 1006, and a network connection device 1007, and these devices are connected to one another through a bus 1008.

The memory 1002 contains ROM (read only memory), RAM (random access memory), etc., for example, and stores programs used for processing and data. CPU 1001 executes the programs by using the memory 1002 to execute necessary processing.

The recording unit that stores the coordinate positions before and after the movement corresponds to the memory 1002. Furthermore, the image selector 2, the image moving unit 3, the post-movement image position obtaining unit 4, the pre-movement image position obtaining unit 5 and the connection line drawing unit 6 illustrated in FIG. 1 correspond to the functions which are implemented by executing the programs stored in the memory 1002.

The input device 1003 may be a keyboard, a pointing device, a touch panel or the like, for example, and is used to input an instruction or information from an operator. The output device 1004 may be a display, a printer, a speaker or the like, for example, and is used to output a graph, etc. as processing results.

The external storage device 1005 may be a magnetic disk device, an optical disc device, a magneto-optic disk device, a tape device or the like, for example. The information processor stores the above programs and data in the external storage device 1005, and loads the above programs and data into the memory 1002 for use as occasion demands.

The medium driving device 1006 drives a portable recording medium 1009, and accesses the recording content thereof. The portable recording medium 1009 is any computer-readable recording medium such as a memory card, a flexible disk, CD-ROM (compact disk read only memory), an optical disk, a magneto-optic disk, or the like. The operator stores the above programs and data into the portable recording medium 1009, and loads them into the memory 1002 for use as occasion demands.

The network connection device 1007 is connected to any communication network such as LAN (local area network), the Internet, or the like, and performs data conversion associated with the communication. The information processor receives the above programs and data from an external device through the network connection device 1007, and loads them into the memory 1002 for use as occasion demands.

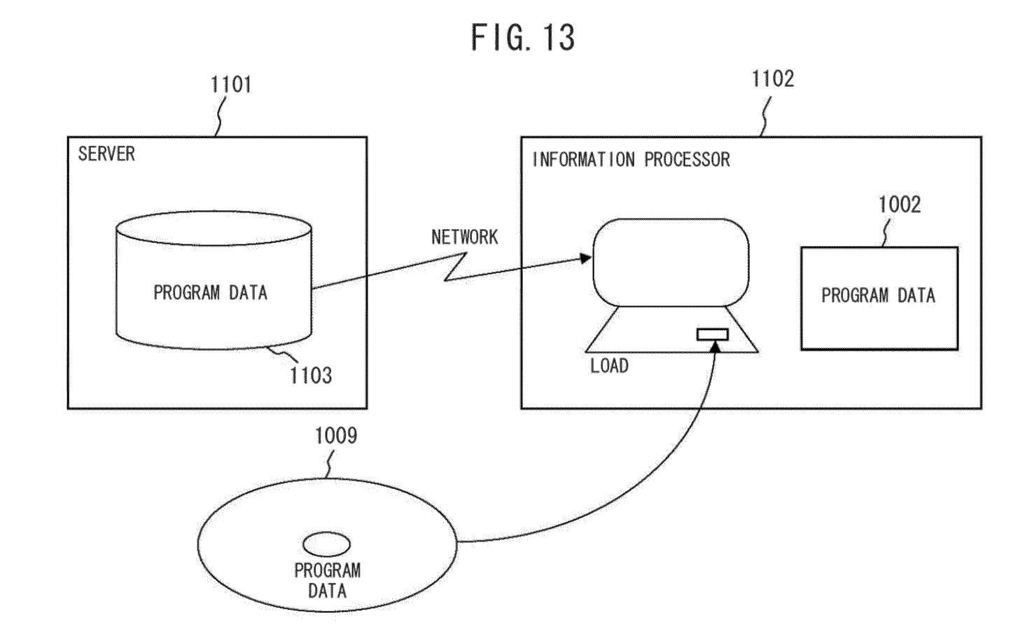

FIG. 13 illustrates a computer-readable recording medium which can supply programs and data to the information processor of FIG. 12. Programs and data stored in the portable recording medium 1009 or a database 1103 of a server 1101 are loaded into the memory 1002 of the information processor 1102. The server 1101 generates a carrier signal for carrying the programs and data, and transmits them to the information processor 1102 through any transmission medium on the network. CPU 1001 executes the programs by using the data and executes desired processing.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A symbol display device for displaying a symbol for data while disposing the symbol at a coordinate position indicated by the data, the symbol display device comprising:
a pre-movement image position obtaining unit that records, into a recording unit, a pre-movement coordinate position at which the symbol is disposed;
an image moving unit that moves the symbol to a coordinate position indicated by an instruction to move the symbol upon reception of the instruction;
a post-movement image position obtaining unit that records, into the recording unit, a post-movement coordinate position of the symbol moved by the image moving unit; and
a connection line drawing unit that connects, by a line, the post-movement coordinate position and a pre-movement coordinate position recorded in the recording unit, and that changes a line thickness of the connecting line or a size of the symbol after a movement in accordance with a distance between the pre-movement and post-movement coordinates.

2. The symbol display device according to claim 1, wherein when there exist a plurality of symbols to be moved based on the instruction, the image moving unit moves the plurality of symbols to a peripheral edge portion of a circle which has, at the center thereof, a pre-movement coordinate of the plurality of symbols to be moved.

3. The symbol display device according to claim 2, wherein the image moving unit determines the distance to a symbol out of symbols other than the plurality of symbols to be moved, the symbol concerned being located at the shortest distance from the plurality of symbols, and determines, based on the determined distance, a radius of a circle which has, at the center thereof, the pre-movement coordinate of the plurality of symbols to be moved.

4. The symbol display device according to claim 2, wherein the image moving unit divides the circle which has the pre-movement coordinate at the center thereof into sectors of a number equivalent to the number of the symbols to be moved, determines a rectangle internally touching each sector, moves each of the symbols to be moved to a position at which each symbol is accommodated in each rectangle, and changes the size of each symbol in accordance with the size of the rectangle in which each symbol is accommodated.

5. The symbol display device according to claim 1, wherein when there exist a plurality of symbols to be moved based on the instruction, the image moving unit moves the plurality of symbols so that the symbols concerned are disposed in a grid arrangement.

6. The symbol display device according to claim 5, wherein the image moving unit determines the distance to a symbol out of symbols other than the plurality of symbols to be moved, the symbol concerned being located at the shortest distance from the plurality of symbols, determines, based on the determined distance, the radius of a circle which has, at the center thereof, the pre-movement coordinate associated with the plurality of symbols to be moved, moves the symbols to be moved into a rectangle internally touching the circle having the determined radius so that the symbols concerned are disposed in a grid-like arrangement, and changes the size of each symbol in accordance with the size of the rectangle.

7. The symbol display device according to claim 1, wherein the image moving unit moves the symbols so that the area of the gaps between the symbols is reduced after the symbols to be moved are moved based on the instruction.

8. The symbol display device according to claim 1, wherein the connection line drawing unit draws the symbol so that the size of the symbol is smaller or a transparency of the symbol is higher as the movement distance of the symbol is longer.

9. The symbol display device according to claim 1, wherein upon reception of an instruction of moving the symbol, the image moving unit moves the symbol to a coordinate indicated by the moving instruction during a specific period, and returns the symbol to the pre-movement coordinate when the specific period elapses.

10. A method of displaying a symbol for data while disposing the symbol at a coordinate position indicated by the data, comprising:
recording, into a recording unit, the coordinate position at which the symbol is disposed;
moving, upon reception of an instruction of moving the symbol, the symbol to a coordinate position indicated by the instruction;
recording, into the recording unit, a post-movement coordinate position of the moved symbol; and
connecting the pre-movement and post-movement coordinate positions recorded in the recording unit by a line, and changing the line thickness of the connecting line or the size of the symbol after the movement in accordance with the distance between the pre-movement and post-movement coordinates.

11. A computer-readable recording medium recorded with a program for displaying a symbol for data while the symbol is disposed at a coordinate position indicated by the data, said program causing a computer device to perform a process comprising:
recording, into a recording unit, the coordinate position at which the symbol is disposed;
moving, upon reception of an instruction of moving the symbol, the symbol to a coordinate position indicated by the instruction;
recording, into the recording unit, a post-movement coordinate position of the moved symbol; and
connecting the pre-movement and post-movement coordinate positions recorded in the recording unit by a line, and changing the line thickness of the connecting line or the size of the symbol after the movement in accordance with the distance between the pre-movement and post-movement coordinates.
